(19) United States
(12) Patent Application Publication
(10) Pub. No.: US 2015/0369318 A1
(43) Pub. Date: Dec. 24, 2015

(54) WEAR DETECTION DEVICE FOR BRAKE PAD A DISK BRAKE

(71) Applicant: MANDO CORPORATION, Pyeongtaek-si (KR)

(72) Inventor: Myeong-Jin KANG, Anyang-si (KR)

(21) Appl. No.: 14/740,950

(22) Filed: Jun. 16, 2015

(30) Foreign Application Priority Data
Jun. 20, 2014 (KR) 10-2014-0075640

(51) Int. Cl. F16D 66/02

(52) U.S. Cl. CPC F16D 66/024

(57) ABSTRACT

Disclosed herein is a wear detection device for a brake pad of a disc brake, in which the disc brake includes a pair of brake pads that squeez a disc rotating together with a wheel of a vehicle at both sides of the disc, and pad plates to which the brake pads are attached. The wear detection device includes a sensor unit having a neck installed on the pad plate, a head extending from the neck to the brake pad, and a leg extending from the neck at a side opposite to the head in one body, an elastic clip configured to fix the neck to the pad plate, a cable connected to the sensor unit, and a connector configured to fix the sensor unit and the cable to the disc brake.

### CROSS-REFERENCE TO RELATED APPLICATION

This application claims the benefit of Korean Patent Application No. 2014-0075640, filed on Jun. 20, 2014 in the Korean Intellectual Property Office, the disclosure of which is incorporated herein by reference.

### BACKGROUND

1. Field

Embodiments of the present invention relate to a wear detection device for a brake pad and, more particularly, to a wear detection device for a brake pad capable of detecting a wear condition of the brake pad to check a timing of replacement.

2. Description of the Related Art

In general, a disc brake for a vehicle is equipped with brake pads on both sides of a disc rotating together with a wheel, squeezes the brake pads during braking to create friction against the disc, and thereby obtains a braking force.

Since the disc is exposed to air, the disc brake shows excellent heat dissipation, and thus maintains the braking force in spite of repetitive squeezes. Since the disc brake is influenced less by a variation in friction coefficient, the disc brake ensures stable braking, and is currently widely distributed to most vehicles.

The disc brake includes a disc that rotates together with a wheel, carriers that movably support a pair of brake pads disposed on both sides of the disc, and a caliper housing that is provided with a piston for pressing the brake pads.

In this disc brake, the condition of the brake pads plays a critical role in braking performance, and thus it is very important to replace the brake pads at a suitable timing.

The brake pad is generally provided with an indicator formed of a metal material. When the brake pad is worn over a predetermined thickness, the indicator warns of a timing of replacement through a frictional sound produced by contact with the disc.

However, the frictional sound occurring at the indicator of the metal material is a metal noise that gives an unpleasant feeling to a driver and a passenger. If the disc brake is continually operated with the brake pads worn, the disc is damaged.

### DOCUMENTS OF RELATED ART

Patent Document 1: Korean Unexamined Patent Application Publication No. 10-1997-0704978 (1997.09.06)

### SUMMARY

Therefore, it is an aspect of the present invention to provide a wear detection device for a brake pad which prevents damage occurring when the wear detection device is installed on a disc brake and makes the installation easy.

Additional aspects of the invention will be set forth in part in the description which follows and, in part, will be obvious from the description, or may be learned by practice of the invention.

According to an aspect of the present invention, a wear detection device for a brake pad of a disc brake, in which the disc brake includes a pair of brake pads that squeez a disc rotating together with a wheel of a vehicle at both sides of the disc, and pad plates to which the brake pads are attached, includes: a sensor unit having a neck installed on the pad plate, a head extending from the neck to the brake pad, and a leg extending from the neck to a side opposite to the head in one body; an elastic clip configured to fix the neck to the pad plate; a cable connected to the sensor unit; and a connector configured to fix the sensor unit and the cable to the disc brake.

Here, the pad plate may include a sensor fixing hole for installing the sensor unit; the sensor fixing hole may include catch steps at a side of an entrance; and the elastic clip may be caught on the catch steps to fix the sensor unit.

Further, the elastic clip may include a base bend that is open upward, deformable catches that extend from the base bend, and wings that are provided at ends of the deformable catches. The base bend may be in contact with the neck of the sensor unit and may elastically support the sensor unit at an inner side thereof, and the deformable catches and the wings may be elastically supported on the catch steps of the sensor fixing hole.

Also, the elastic clip may enclose the neck to elastically support the sensor unit at an inner side thereof and the pad plate at an outer side thereof.

Further, the sensor unit may be formed of a material obtained by mixing polyphenylene sulfide (PPS) and glass fibers (GFs).

Further, the elastic clip may be provided for the neck in one body.

Furthermore, the elastic clip may be formed of a metal and be molded with the sensor unit by dual-injection molding.

Also, the leg may include a neck tail that protrudes from the neck to a side opposite to the head, and a leg wing that is coupled to the neck tail to fix the sensor unit to the pad plate in a direction in which the disc is pressed.

Here, the neck tail may include tail grooves that are recessed inward from above to below; and the leg wing may include leg protrusions on an inner wall thereof so as to be inserted into the tail grooves.

Further, the head may include a through-hole through which the cable passes in a central portion thereof; the neck may have a shape of a fork in which a middle portion thereof branches off; and the cable may enclose a space between the through-hole and the fork in a circular shape to form a closed loop.

According to an aspect of the present invention, a wear detection device for a brake pad of a disc brake, in which the disc brake includes a pair of brake pads that squeez a disc rotating together with a wheel of a vehicle at both sides of the disc, and pad plates to which the brake pads are attached, includes: a sensor unit having a neck installed on the pad plate, a head extending from the neck to the brake pad, and a neck tail extending from the neck to a side opposite to the head in one body; a leg wing coupled to the neck tail to fix the sensor unit to the pad plate in a direction in which the disc is pressed; a cable connected to the sensor unit; and a connector configured to fix the sensor unit and the cable to the disc brake. The leg wing includes seating noses on an inner surface thereof coming into contact with the pad plate such that the leg is prevented from moving in an upward/downward direction; the pad plate includes seating recesses in one surface thereof coming into contact with the leg wing; and the seating noses and the seating recesses are forcible form-fitted when the leg and the pad plate are assembled.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a caliper housing in which a wear detection device for a brake pad according to a first embodiment of the present invention is installed;

FIG. 2 is an exploded view illustrating the wear detection device for the brake pad according to the first embodiment of the present invention;

FIG. 3 is a longitudinal sectional view illustrating a sensor unit in the wear detection device for the brake pad according to the first embodiment of the present invention;

FIG. 4 is a longitudinal sectional view illustrating a sensor unit in the wear detection device for the brake pad according to the first embodiment of the present invention;

FIG. 5 is a view illustrating a wear detection device for a brake pad according to a second embodiment of the present invention;

FIG. 6 is a view illustrating a wear detection device for a brake pad according to a third embodiment of the present invention;

FIG. 7 is a view illustrating a wear detection device for a brake pad according to a fourth embodiment of the present invention; and

FIG. 8 is an enlarged view illustrating a part of a caliper housing in which the wear detection device for the brake pad according to the fourth embodiment of the present invention is installed.

### DETAILED DESCRIPTION

Reference will now be made in detail to the embodiments of the present invention with reference to the accompanying drawings. Here, the embodiments described below are merely provided as examples such that the idea of the present invention can be sufficiently delivered to those skilled in the art. Therefore, the present invention is not limited to the embodiments described below, and may be embodied in other ways. Furthermore, to clearly describe the present invention, the portions irrelevant to the description will be omitted in the drawings. In the drawings, the widths, lengths, thicknesses, etc. of components may be exaggerated for convenience of description, Like reference numerals refer to like components throughout the specification.

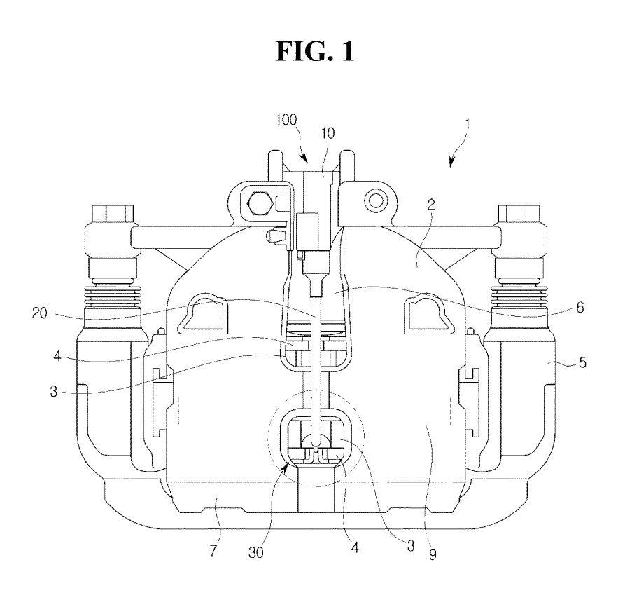

FIG. 1 is a view illustrating a disc brake equipped with a wear detection device for a brake pad according to a first embodiment of the present invention.

The disc brake 1 includes a caliper housing 2 in which a piston (not shown) is installed to move forward or backward by a braking hydraulic pressure, a disc 9 that rotates together with a wheel of a vehicle, and carriers 5 on which pad plates 4, to inner surfaces of which brake pads 3 are attached, are installed so as to squeeze the disc and which are fixed to a vehicle body. The brake pads 3 and the pad plates 4 are provided across the disc in pairs so as to be able to press the disc at both sides of the disc at the same time. The brake pad provided at a side of the piston is referred to as an inner brake pad, and the brake pad provided at the opposite side of the piston is referred to as an outer brake pad.

Further, the caliper housing 2 includes a cylinder 6 in which the piston is mounted, and a finger part 7 that operates the outer brake pad 3 of the pair of brake pads. The cylinder 6 is provided in the rear of the caliper housing 2 such that a braking hydraulic pressure established at a master cylinder (not shown) is transmitted. The finger part 7 is bent downward in the front of the caliper housing 2 so as to enclose the outer brake pad 3, and has a space by which the center thereof is disconnected. The disc having a circular plate shape is fixed to the wheel of the vehicle such that a part of an outer circumference thereof rotates between the pair of pad plates at a predetermined interval.

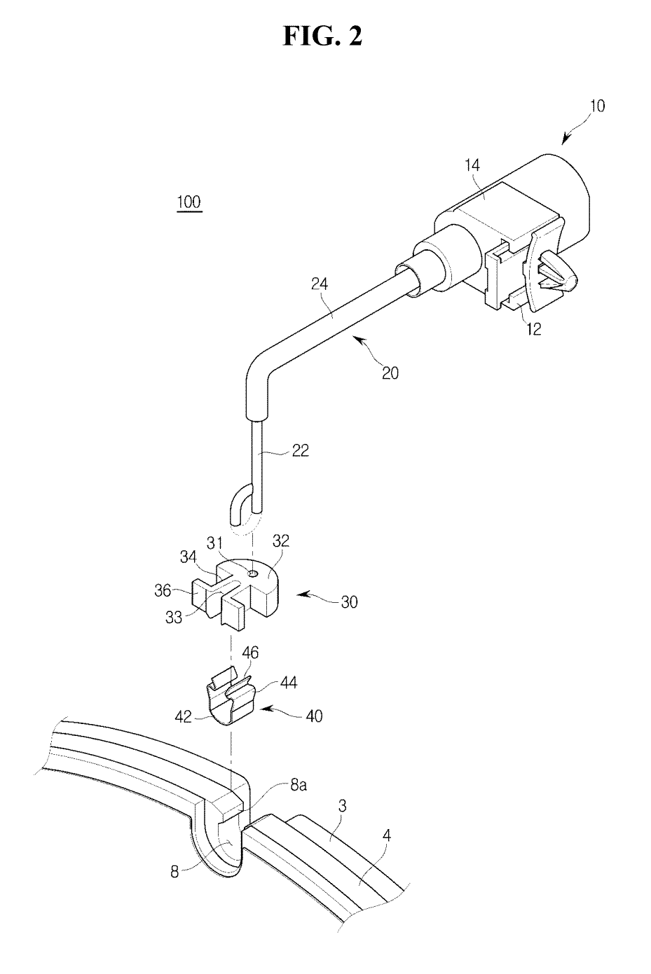

FIG. 2 illustrates the wear detection device for the brake pad according to the first embodiment of the present invention.

Referring to FIG. 2, the wear detection device 100 of the present embodiment includes a connector 10 that is provided at an upper portion of the caliper housing 2 and is fixed to the caliper housing 2, a cable 20 that is provided and extends from the connector 10, and a sensor unit 30 that is connected to the cable 20 and is installed on the brake pad 3.

The connector 10 includes a mount 12 for installing the wear detection device 100 in the caliper housing 2, and a body 14 provided with terminals and a circuit for transmitting a signal detected by the sensor unit 30 to an electronic control unit (not shown) of the vehicle. In the present embodiment, the connector 10 is fixed to bolts provided in the rear of the caliper housing 2, but a fixed position thereof may be appropriately changed.

The cable 20 is provided with a bundle of cores 22 therein. The cores 22 connect the connector 10 and the sensor unit 30. The cores for the connector 10 are electrically connected to the circuit and terminals of the connector body 14. As will be described below, the cores for the sensor unit 30 are installed to enclose the sensor unit 30 and to be able to come into contact with the disc when worn to a predetermined thickness along with the brake pad 3. The cable 20 transmits an electrical signal (clue) generated when the cores create friction against the disc at the sensor unit 30 to the circuit of the connector 10, and is clad with a protection tube 24 to protect the cores and to maintain a bent state.

The sensor unit 30 includes a head 32 that is installed on the brake pad 3, and preferably the pad plate 4, so as to protrude from the brake pad 3 provided for one surface of the pad plate, a neck 34 that is fixedly inserted into a sensor fixing hole 8 of the pad plate 4, and a leg 36 that is provided for the other surface of the pad plate which is the opposite side of the head 32 such that the sensor unit 30 can be supported in a direction in which the disc is pressed.

The head 32, the neck 34, and the leg 36 are formed of a high-strength synthetic resin in one body. For example, the sensor unit 30 is formed of a material obtained by mixing 60 to 65% by weight polyphenylene sulfide (PPS) and 35 to 40% by weight glass fibers (GFs). PPS is called a super engeering plastic, is strong enough to withstand heat of 250° C., and has high strength and light weight. GFs are used to prevent the sensor unit 30 coming into contact with the disc formed of a metal material from being excessively molten by frictional heat.

To be specific, the head 32 has a semi-circular shape, and is provided with a through-hole 31 through which the cable 20 passes in a central portion thereof. The neck 34 extends from the head 32 in the shape of a fork in which a middle portion thereof branches off. The cable 20 starts from the connector body 14, encloses a space 33 between the through-hole 31 and the neck in a closed loop shape, and returns to the connector body 14. The head 32 and the leg 36 are supported on the pad plate 4 such that they are at least provided to be larger than the neck 34 inserted into the sensor fixing hole 8, and thus the sensor unit 30 is prevented from escaping in the direction in which the disc is pressed.

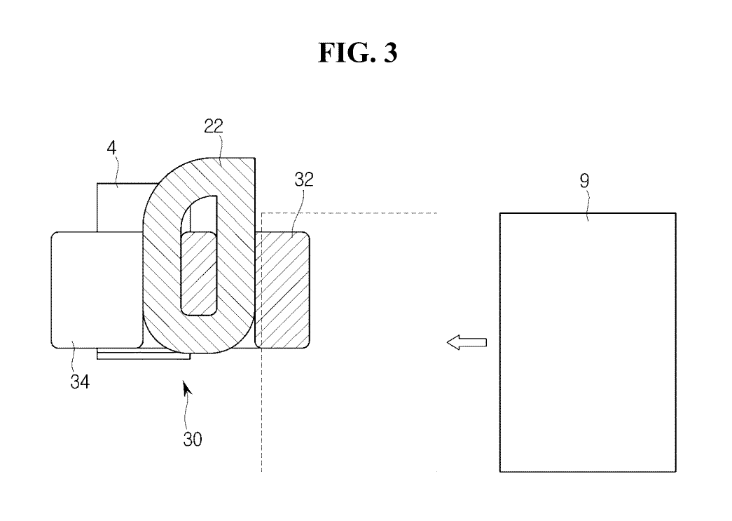

FIG. 3 is an enlarged view illustrating the sensor unit and the cable. When the brake pad 3 is brought into contact with the disc 9 and is gradually worn due to repetitive braking, the head 32 of the sensor unit 30 and the cores 22 of the cable 20, both of which protrude toward the brake pad 3, are worn, and thus the cores 22 are disconnected. An electrical signal caused by this disconnection is transmitted to the electronic control unit of the vehicle, and informs a driver of a timing of replacement of the brake pads. It is illustrated in FIG. 3 as if the disc 9 moves in an arrow direction for convenience of description. However, the brake pad 3 and the sensor unit 30 actually move toward the disc 9 and are worn.

The pad plate 4 is formed of a high-strength metal, and the sensor unit 30 of the wear detection device 100 is formed of a high-strength synthetic resin. Therefore, if a tolerance is not controlled when the sensor unit 30 of the wear detection device 100 is installed on the high-strength pad plate 4, the sensor unit 30 may possibly be damaged.

In the present embodiment, an elastic clip 40 is provided between the pad plate 4 and the sensor unit 30 such that the pad plate 4 and the sensor unit 30 are easily fastened.

As illustrated in FIG. 2, the elastic clip 40 has a U shape in which one side thereof is open, and is provided so as to be able to elastically press and support the sensor unit 30 at an inner side thereof and the pad plate 4 at an outer side thereof.

The elastic clip 40 is formed by bending a metal sheet having elasticity, and includes a base bend 42 that is open upward, deformable catches 44 that extend from the base bend 42, and wings 46 that are provided at ends of the deformable catches 44. The base bend 42 has substantially the same inner diameter as a width of the neck 34 of the sensor unit 30, and elastically supports the sensor unit 30 at an inner side thereof. A distance between transitions, each of which is located between each deformable catch 44 and each wing 46, is smaller than the width of the neck 34 of the sensor unit 30. Thus, the elastic clip 40 is elastically supported in the sensor fixing hole 8 of the pad plate 4.

Meanwhile, the pad plate 4 has the sensor fixing hole 8 so as to be able to easily fix and install the elastic clip 40 in which the sensor unit 30 is mounted. The sensor fixing hole 8 has catch steps 8a at an entrance side thereof.

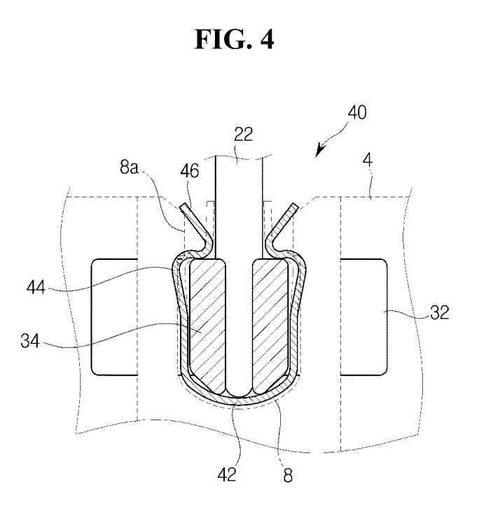

As illustrated in FIG. 4, the elastic clip 40 is vertically inserted into the sensor fixing hole 8 in an elastically deformed state such that the deformable catches 44 are not caught on the catch steps 8a by applying an external force to the wings 46 in a state in which the sensor unit 30 is mounted in the elastic clip 40 (see a dashed line). The external force applied to the wings 46 after the insertion is removed, and thereby an outer side of the elastic clip 40 is elastically fixed to the catch steps 8a (see a solid line).

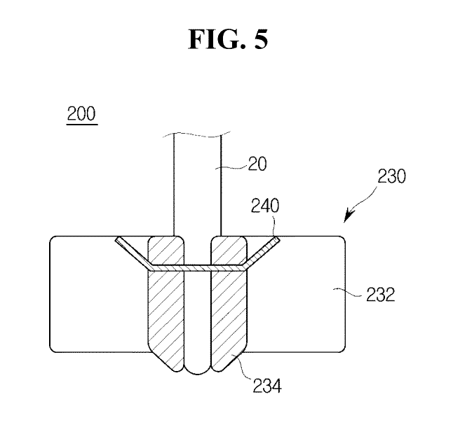

FIG. 5 is a view illustrating a sensor unit in a wear detection device for a brake pad according to a second embodiment of the present invention. Here, the present embodiment will be described centering on differences from the first embodiment. Since the same components having the same reference numerals have the same functions, detailed description will be omitted.

The wear detection device 200 according to the present embodiment is identical to that of the first embodiment in that the sensor unit 230 is provided with a head 232, a neck 234, and a leg 236.

In the present embodiment, when the sensor unit 230 is molded, an elastic clip 240 formed of a metal may be integrally molded, for instance, by dual-injection molding without being provided separately from the sensor unit 230. That is, as illustrated in FIG. 5, the elastic clip 240 is provided at an upper side of the neck 234 of the sensor unit 230 so as to be inclined upward from the center to opposite ends thereof. The elastic clip 240 is inserted into a sensor fixing hole of a pad plate 4, and is fixed to catch steps 8a of the pad plate 4. Thereby, the sensor unit 230 is easily mounted as in the first embodiment. The leg 236 is not illustrated in the figure.

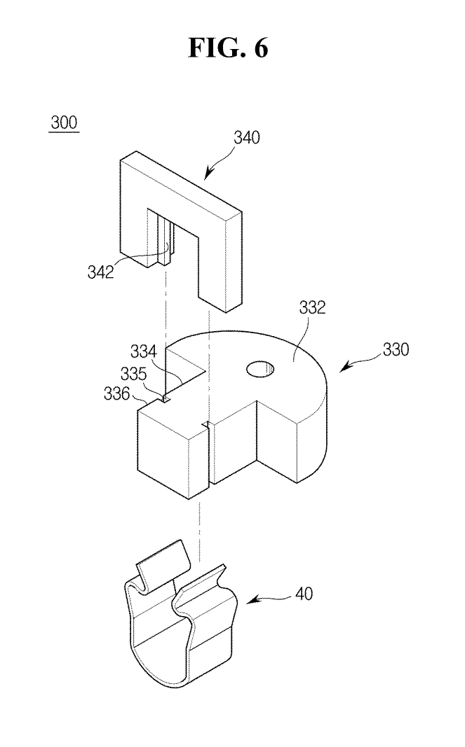

FIG. 6 is a view illustrating a sensor unit in a wear detection device for a brake pad according to a third embodiment of the present invention. Here, the present embodiment will be described centering on differences from the aforementioned embodiments. Since the same components having the same reference numerals have the same functions, detailed description will be omitted.

In the wear detection device 300 according to the present embodiment, the sensor unit 330 includes a head 332 and a neck 334, and a leg 340 is provided separately from the sensor unit 330. For example, the leg 340 is a member for fixing the sensor unit 330 to a brake pad 3 in a direction in which a disc is pressed. In the present embodiment, the leg wing 340 acts as a fixing member provided separately in place of the leg that is integrally formed with the sensor unit 30.

As illustrated in FIG. 6, the leg wing 340 is provided in a D shape, and is fixed to a neck tail 336 of the neck 334 that protrudes from a pad plate 4 to the opposite side of a brake pad 3. The neck tail 336 includes tail grooves 335 that are recessed inward from above to below. The leg wing 340 is fixed to the neck 334 by inserting leg protrusions 342 provided at an inner wall thereof into the tail grooves 335.

The sensor unit 330 including the head 332, the neck 334, and the leg wing 340 may be fixedly installed on the pad plate 4 using an elastic clip 40 as in the first embodiment. In this way, providing the leg wing 340 separately from the sensor unit 330 is to reduce a defective rate caused by a complicated shape when the sensor unit formed of a high-strength resin is produced to thereby increase mass productivity.

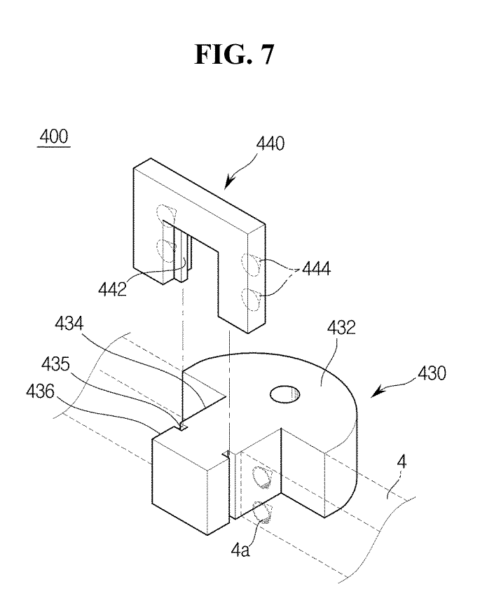

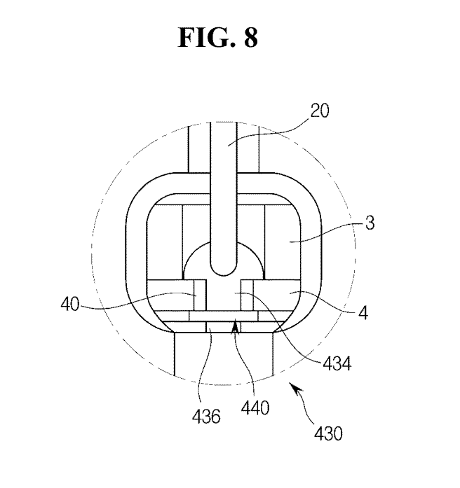

FIGS. 7 and 8 are views illustrating a sensor unit in a wear detection device for a brake pad according to a fourth embodiment of the present invention. Here, the present embodiment will be described centering on differences from the aforementioned embodiments. Since the same components having the same reference numerals have the same functions, detailed description will be omitted.

In the wear detection device 400 according to the present embodiment, the sensor unit 430 includes a head 432, a neck 434, and a leg wing 440 as in the third embodiment.

As illustrated in FIGS. 7 and 8, the leg wing 440 is provided in a D shape, and is fixed to a neck tail 436 of the neck 434 that protrudes from a pad plate 4 to the opposite side of a brake pad 3. The neck tail 436 includes tail grooves 435 that are recessed inward from above to below. The leg wing 440 can be fixed to the neck 434 by inserting leg protrusions 442 provided at an inner wall thereof into the tail grooves 435.

Meanwhile, unlike the aforementioned embodiments, the present embodiment does not use an electric clip 40 and a sensor fixing hole 8 which install the sensor unit 430 on the pad plate 4. For example, as illustrated in the figures, seating noses 444 are provided for an inner surface of the leg wing 440 coming into contact with the pad plate 4 such that the pad plate 4 and the leg wing 440 are prevented from moving in an upward/downward direction in which they are assembled. Seating recesses 4a are provided for an outer surface of the pad plate 4 facing the seating noses 444. The seating noses 444 and the seating recesses 4a may be forcibly form-fitted when assembled. In this way, when the sensor unit 430 is fixed to the pad plate 4 in a recess and nose type, the catch steps of the sensor fixing hole 8 can be omitted, and thus productivity can be increased. Further, in the present embodiment, the leg wing 440 is formed of a synthetic resin, and the seating noses 444 are integrally formed with the the leg wing 440. However, the present invention is not limited thereto, the the leg wing 440 may be formed of a metal, and the seating noses 444 may be formed in a bent shape.

The wear detection device for the brake pad according to each embodiment of present invention is configured to interpose the elastic clip between the high-strength pad plate and the sensor unit to facilitate installation of the wear detection device, and can effectively prevent damage occurring when installed.

Further, in the wear detection device for the brake pad according to each embodiment of present invention, the sensor unit is provided with the neck, and is firmly supported on the pad plate in the direction in which the disc is pressed. Further, since the elastic clip elastically supports the sensor unit at inner and outer sides thereof, the sensor unit can maintain a firmly coupled state in spite of external shocks.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A wear detection device for a brake pad of a disc brake, in which the disc brake includes a pair of brake pads that squeez a disc rotating together with a wheel of a vehicle at both sides of the disc, and pad plates to which the brake pads are attached, the wear detection device comprising:
a sensor unit having a neck installed on the pad plate, a head extending from the neck to the brake pad, and a leg extending from the neck to a side opposite to the head in one body;
an elastic clip configured to fix the neck to the pad plate;
a cable connected to the sensor unit; and
a connector configured to fix the sensor unit and the cable to the disc brake.

2. The wear detection device according to claim 1, wherein:
the pad plate includes a sensor fixing hole for installing the sensor unit;
the sensor fixing hole includes catch steps at a side of an entrance; and
the elastic clip is caught on the catch steps to fix the sensor unit.

3. The wear detection device according to claim 2, wherein:
the elastic clip includes a base bend that is open upward, deformable catches that extend from the base bend, and wings that are provided at ends of the deformable catches; and
the base bend is in contact with the neck of the sensor unit and elastically supports the sensor unit at an inner side thereof, and the deformable catches and the wings are elastically supported on the catch steps of the sensor fixing hole.

4. The wear detection device according to claim 1, wherein the elastic clip encloses the neck to elastically support the sensor unit at an inner side thereof and the pad plate at an outer side thereof.

5. The wear detection device according to claim 1, wherein the sensor unit is formed of a material obtained by mixing polyphenylene sulfide (PPS) and glass fibers (GFs).

6. The wear detection device according to claim 1, wherein the elastic clip is provided for the neck in one body.

7. The wear detection device according to claim 6, wherein the elastic clip is formed of a metal and is molded with the sensor unit by dual-injection molding.

8. The wear detection device according to claim 1, wherein the leg includes a neck tail that protrudes from the neck to a side opposite to the head, and a leg wing that is coupled to the neck tail to fix the sensor unit to the pad plate in a direction in which the disc is pressed.

9. The wear detection device according to claim 8, wherein:
the neck tail includes tail grooves that are recessed inward from above to below; and
the leg wing includes leg protrusions on an inner wall thereof so as to be inserted into the tail grooves.

10. The wear detection device according to claim 1, wherein:
the head includes a through-hole through which the cable passes in a central portion thereof;
the neck has a shape of a fork in which a middle portion thereof branches off; and
the cable encloses a space between the through-hole and the fork in a circular shape to form a closed loop.

11. A wear detection device for a brake pad of a disc brake, in which the disc brake includes a pair of brake pads that squeez a disc rotating together with a wheel of a vehicle at both sides of the disc, and pad plates to which the brake pads are attached, the wear detection device comprising:
a sensor unit having a neck installed on the pad plate, a head extending from the neck to the brake pad, and a neck tail extending from the neck to a side opposite to the head in one body;
a leg wing coupled to the neck tail to fix the sensor unit to the pad plate in a direction in which the disc is pressed;
a cable connected to the sensor unit; and
a connector configured to fix the sensor unit and the cable to the disc brake,
wherein the leg wing includes seating noses on an inner surface thereof coming into contact with the pad plate such that the leg is prevented from moving in an upward/downward direction; the pad plate includes seating recesses in one surface thereof coming into contact with the leg wing; and the seating noses and the seating recesses are forcible form-fitted when the leg and the pad plate are assembled.
